(19) United States
(12) Patent Application Publication
(10) Pub. No.: US 2024/0351229 A1
(43) Pub. Date: Oct. 24, 2024

(54) HAIR-CUTTING DEVICE, CHARGER, AND RECHARGEABLE BATTERY

(71) Applicant: WAHL GMBH, St. Georgen (DE)

(72) Inventor: Gerd EMMINGER, Niedereschach (DE)

(73) Assignee: WAHL GMBH, St. Georgen (DE)

(21) Appl. No.: 18/708,013

(22) PCT Filed: Nov. 4, 2022
(86) PCT No.: PCT/EP2022/080844

§ 371 Date: May 7, 2024

(30) Foreign Application Priority Data
Nov. 8, 2021 (DE) 10 2021 129 025.2

(51) Int. Cl. B26B 19/38; H02J 7/00

(52) U.S. Cl. CPC B26B 19/3853; B26B 19/3873; H02J 7/0045; H02J 2207/20

(57) ABSTRACT

The invention relates to a hair-cutting device (100) comprising: a housing; a blade assembly for cutting hair; a motor (130) for driving the blade assembly, which motor is located in the housing; a receiving space (140) for at least partially receiving a rechargeable battery, the receiving space (140) being located in the housing and having, in the longitudinal direction (170), at least one bottom and, on the periphery, one wall or multiple walls which delimit the receiving space (140); and a plug connection (160) for plugging in the rechargeable battery, the plug connection (160) being electrically connected to the motor (130).

### FIELD OF THE INVENTION

The invention relates to a hair cutting device with a receiving space for a battery, a charger with a receiving space for a battery and a battery for such a receiving space.

### STATE OF THE ART

Hair cutting devices are usually fitted with batteries that are inserted into conventional battery slots in the housing of the hair-cutting device. These battery slots are then covered and sealed with a lid, which then holds the batteries in the slots. Batteries are either permanently installed in hair cutting devices so that they cannot be replaced or are inserted into a holder in the same way as batteries and are then held in the holder by means of a cover. The batteries are usually charged by connecting the hair-cutting device to a power outlet. During the charging process, however, the hair-cutting device can only be used to a limited extent due to the power outlet connection realized by means of a cable.

Furthermore, it is also known that in other portable small electrical appliances, for example hand-held power tools with replaceable rechargeable batteries, which have a battery socket on the machine itself, a plug-in battery can be attached in a replaceable manner. The rechargeable batteries contain at least one rechargeable battery component to supply the small electrical appliance with electrical energy. As a rule, the battery holder and the casing of the rechargeable battery have at least one corresponding electrical interface, as well as a mechanical interface or a battery holding system, or a combination thereof, so that the rechargeable battery can be detachably and securely connected to the small electrical appliance to be operated or to a charger.

The solutions for battery holding systems known in the state of the art generally have an actuating element which must be actuated to fasten or at least to release the mechanical interface.

The battery can only be removed after releasing a latch, for example by pressing in the side tabs. This requires an additional operating step, which makes handling the small electrical appliance more difficult and it is also not possible to replace the battery with one hand. Furthermore, additional components are required to realize the latching and releasing of the latch. These require additional installation space, which makes handling the small electrical appliance more difficult or prevents optimum utilization of the available design space for the largest possible battery component. The additional components also increase the cost of manufacturing the small electrical appliance.

### DESCRIPTION OF THE INVENTION

The task of the present invention is therefore to provide an easy-to-handle, space-saving and cost-effective battery holding system.

This task is accomplished by a hair cutting device according to claim 1, a charger according to claim 2 and a rechargeable battery according to claim 12. Further features shaping the invention are contained in the dependent claims.

A hair cutting device according to the invention comprises a housing, a blade assembly for cutting hair, a motor for driving the blade assembly, which is arranged in the housing, a receiving space for at least partially receiving a battery, the receiving space being arranged in the housing and having in the longitudinal direction at least one bottom and circumferentially one wall or a plurality of walls which delimit the receiving space, and a plug connection for plugging in the battery, the plug connection being electrically connected to the motor. Furthermore, the receiving space has circumferentially at least one elastic or elastically mounted clamping element, with which a radially inwardly directed pressure can be exerted via a holding area on the battery received in the receiving space, or the receiving space has circumferentially at least one recess for receiving an elastic or elastically mounted clamping element arranged on the battery held in the receiving space. Instead of the hair cutting device, any other small electrical appliance can be provided, whereby a hair cutting device is preferred. The holding area is defined as the contact point via which the holding force of the clamping element is exerted on the battery. Such a hair-cutting device makes it possible to simply insert and release the battery without the need for additional actuating elements. The means provided for this purpose enable a space-saving design and arrangement. Furthermore, such a hair cutting device can be manufactured at low cost. In particular, the rechargeable battery compartment is also designed without a cover so that the rechargeable battery can protrude from the receiving space. Such a lidless design makes it easy to insert and remove the battery with one hand. The housing can also have a lateral recess so that the inserted battery can be handled at this recess. In particular, the battery has a grip area at the point corresponding to the recess.

The housing of the hair cutting device is preferably made of a plastic or a metal or a mixture of both materials. A design made of plastic enables the hair-cutting device to be manufactured cost-effectively, whereas a design made of metal enables a robust design.

The inner contour of the receiving space is preferably adapted to the outer contour of the battery in such a way that as little empty space as possible results in the inserted state or operational state. On the one hand, this improves the manageability of the hair cutting device and, on the other hand, a battery component with the highest possible charging capacity can be used, which increases the maximum possible operating time.

Preferably, the rechargeable battery can be connected to the motor by simply inserting it into the housing so that the hair-cutting device is ready for operation without the need for additional connection steps. For this purpose, the plug connection is preferably suitable for directly accommodating the electrical contacts of the battery.

The clamping element or the recess in the receiving space is designed in such a way that the rechargeable battery can be inserted easily and reversibly, and the hair-cutting device can be operated safely even during vigorous movements, for example when the hair-cutting device is put down quickly. For this purpose, the clamping element or the recess of the receiving space and its corresponding components of the battery are dimensioned and designed in such a way that the pressure exerted by the clamping element causes such a frictional adhesion that the battery is fixed in the hair cutting device. Furthermore, the clamping element or the recess of the receiving space and its corresponding components of the battery are dimensioned and designed in such a way that, in addition to the frictional adhesion in the state of the inserted battery, a form-fit also results.

An elastic clamping element according to the invention preferably consists of an elastic material. Such an elastic material can be a metal, for example a spring steel, but also a plastic, in particular an elastomer or rubber.

An elastically mounted clamping element according to the invention preferably consists of a rigid material and has an elastic or deflectable bearing area. Such a rigid material can be a metal, for example a rigid steel, but also a plastic, for example a polyamide or a polycarbonate. This clamping element is then rotatably mounted, for example, and can have a spiral spring which is attached to both the housing and the clamping element, and which then tensions the clamping element mounted on a bearing pin.

A charger for a battery according to the invention comprises a connection which can be connected to a mains supply, a converter which converts the current and voltage from the mains supply into a current and voltage suitable for a battery, a plug connection for plugging in the battery, so that the battery can be supplied with the converted current and voltage, and a receiving space for at least partially receiving a battery, the receiving space being arranged in the housing and having, in the longitudinal direction, at least one bottom and circumferentially one wall or a plurality of walls which delimit the receiving space. The charger according to the invention is characterized in that the receiving space has circumferentially at least one resilient or elastically mounted clamping element, with which a radially inwardly directed pressure can be exerted via a holding area on the battery received in the receiving space, or the receiving space has circumferentially at least one recess for receiving a resilient or elastically mounted clamping element arranged on the battery received in the receiving space. Such a charger makes it possible to simply insert and remove the battery without the need for additional actuating elements. The means provided for this purpose enable a space-saving design and arrangement. Furthermore, such a charger is inexpensive to manufacture.

The description of components relating to the hair-cutting device, which are the same in the hair-cutting device and in the charger, applies analogously to the charger.

A converter according to the invention is designed in such a way that the current and voltage are converted in such a way that the battery can be charged quickly but without overloading. Depending on the specification of the battery, different currents and voltages are possible.

Preferably, the clamping element is designed as a circumferential bulge, or the hair-cutting device or charger has a large number of circumferentially arranged clamping elements. This enables the battery to be clamped over the circumference with a simple design, without it being able to deflect along the clamping, which would reduce the clamping effect. A high clamping effect can therefore be achieved in this way.

Preferably, an angle between the outer surface of the holding area and an insertion direction of the battery is less than 75°, even more preferably less than 60°, in particular preferably less than 45° and greater than 10°, even more preferably greater than 20° and in particular preferably greater than 30°. On the one hand, this additionally increases the safety of the clamping or the clamping effect. On the other hand, this reduces the load on the components or areas involved in the clamping, in particular the holding area and the recess, thereby increasing their durability. The insertion direction of the battery essentially corresponds to the main direction of the receiving space, i.e. the direction that points vertically from the opening of the receiving space into the same. Preferably, the battery can be inserted along a straight line, which makes it easier to handle. However, non-straight curves along which the battery can be inserted are also conceivable, which can increase the clamping effect or security of the fixing of the battery. On the one hand, the angle refers to the surface of the holding area that is in contact with the recess, particularly when the battery is released. On the other hand, the angle refers to the direction along which the battery can be pulled out in the initial contact state. By selecting a suitable angle according to the upper and lower limits of the invention, the battery is prevented from tilting and being damaged when it is released. This also enables the battery to be clamped as securely as possible.

The holding area can be arranged at the end of the clamping element that first comes into contact when the rechargeable battery is inserted into the hair-cutting device or the charger.

Alternatively, the retaining area can be located at the end of the clamping element that comes into contact last when the battery is inserted into the hair-cutting device or charger. This can make it easier to insert or center the battery.

Preferably, the clamping element is made of an elastically deformable plastic. This can reduce manufacturing costs. In addition, the weight of the hair cutting device can be reduced, which also improves its manageability.

Preferably, the at least one clamping element is designed as a flat leaf spring element that protrudes into the receiving space in the longitudinal direction and is pretensioned in the radial direction. Such a leaf spring element is also a structurally simple solution for a clamping element, which is less prone to wear than a plastic protrusion, especially if it is made of metal.

Preferably, the clamping element is attached in one piece to a base plate, which is arranged at the bottom of the receiving space. The base plate is in particular preferably attached to the bottom of the receiving chamber. Attached in one piece to a base plate means that the clamping element and the base plate are made from one piece. This simplifies the assembly of the hair-cutting device or charger. In addition, the load-bearing capacity of the clamping element can be increased, as it is additionally supported by the base plate.

Preferably, the hair-cutting device or charger has at least two clamping elements, at least two of which are at least partially aligned with each other. Partially aligned means that the perpendiculars to the surfaces of the clamping elements, along which pressure can be exerted and which point towards the center of the receiving space, have a common point of intersection. This point of intersection can be in the receiving space or outside it. The closer the intersection point is to the respective clamping elements, the more strongly they are aligned with each other, the more opposing pressure can be exerted on the battery. If the clamping elements are exactly aligned with each other, these directions are congruent but opposite. In this case, there is no longer a single point of intersection.

In this way, pressure can be exerted on the battery from different sides by means of the clamping elements so that it is securely clamped.

It is particularly preferable that the clamping elements are aligned with each other in such a way that a balanced clamping effect is created so that the torques acting on the battery are equalized.

Preferably, the base plate has a recess through which the battery can be connected to the plug connection, making it easy to connect the battery to the motor or the converter.

Preferably, the clamping element is made of metal or plastic. The above explanations regarding the materials metal and plastic in relation to the clamping element apply analogously here.

Preferably, the holding area has no edges. This makes it possible to gently slide the battery into the fixing position and also gently release it from this position. This minimizes the abrasion or damage that could potentially be caused when inserting and releasing the battery. The fixing position or locking position is the position in which the at least one clamping element is in engagement with the recess, i.e. the battery is fixed or locked in its operating position.

A battery according to the invention for a hair cutting device comprises at least one battery component, a casing in which the at least one battery component is accommodated, and a connection element which can be connected to the plug connection of the hair cutting device. The battery according to the invention is characterized in that at least one resilient or elastically mounted clamping element is arranged circumferentially on the outside of the sheath, which exerts a radially outwardly directed pressure on the receiving space via a holding area or has at least one recess on the outside of the sheath circumferentially for receiving a resilient or elastically mounted clamping element arranged in the receiving space of the hair cutting device.

The battery component is preferably rechargeable, preferably a secondary cell or a secondary element.

Such a battery is suitable for operating a hair cutting device according to the invention and a charger according to the invention and enables simple, safe, and rapid insertion and removal of the battery.

Preferably, the clamping element is designed as a circumferential bulge, or the battery has a plurality of circumferentially arranged clamping elements. In this way, a circumferentially uniform clamping effect can be achieved in relation to the battery.

Preferably, an angle between the outer surface of the holding area and an insertion direction of the battery is less than 75°, even more preferably less than 60°, in particular preferably less than 45° and greater than 10°, even more preferably greater than 20° and in particular preferably greater than 30°. On the one hand, this enables the battery to slide gently into and out of the fixing position. If the angle is too large, up to 90°, the battery would be jammed in the fixing position to such an extent that it could only be released with the risk of damaging the clamping elements or the recess. On the other hand, this enables secure clamping. The angle must not be too small for this, as there would then be a risk of the battery slipping out of its fixing position unintentionally.

Preferably, the clamping element of the battery is made of an elastically deformable plastic. The aspects described above with regard to clamping elements of the hair-cutting device or charger apply analogously.

Preferably, the recess of the battery is formed as an at least substantially circumferential groove.

This makes it possible for the battery to be inserted into a holding space with a large number of clamping elements.

Preferably, the battery also has a grip area for manual handling. The grip area can be designed as an area with increased surface roughness in order to enable increased static friction locally. The grip area can also be represented as a depression or a bulge or a combination of both in order to locally create an area in which a form-fit between the fingers of the hand and the battery is made possible during handling. The grip area can also be designed as a large number of successive grooves, which also enable a form fit. This facilitates the insertion and release of the battery into and out of the fixing position.

Furthermore, one aspect of the invention is also a combination of a hair cutting device or a charging device with such a battery. This applies in particular if the battery protrudes from the hair cutting device when inserted into the receiving space.

### BRIEF DESCRIPTION OF THE FIGURES

FIG. 1a shows a preferred hair cutting device in a side sectional view.

FIG. 1b shows a sectional view of the hair cutting device shown in FIG. 1a.

FIG. 1c shows a section through the receiving space of the hair cutting device shown in FIGS. 1a and 1b.

FIG. 1d shows a detail of the section shown in FIG. 1c.

FIG. 2a shows a preferred battery with two integrally formed clamping elements with base plate in the fixing position in an isometric view.

FIG. 2b shows a side view of the arrangement shown in FIG. 2a.

FIG. 2c shows a top view of the arrangement shown in FIGS. 2a and 2b.

FIG. 2d shows the arrangement shown in FIGS. 2a to 2c from below.

FIG. 2e shows a sectional view of the arrangement shown in FIGS. 2a to 2d.

FIG. 2f shows a detail of the sectional view shown in FIG. 2e.

FIG. 2g shows an isometric view of the two integrally formed clamping elements with base plate shown in FIGS. 2a to 2f.

FIG. 2h shows the arrangement shown in FIG. 2g in another isometric view.

FIG. 2i shows the arrangement shown in FIGS. 2g and 2h from above.

FIG. 2j shows the arrangement shown in FIGS. 2g to 2i from the front.

FIG. 2k shows the arrangement shown in FIGS. 2g to 2j from the side.

FIG. 3a shows a preferred battery with four integrally formed clamping elements with base plate in the fixing position in an isometric view.

FIG. 3b shows a side view of the arrangement shown in FIG. 3a.

FIG. 3c shows a top view of the arrangement shown in FIGS. 3a and 3b.

FIG. 3d shows the arrangement shown in FIGS. 3a to 3c from below.

FIG. 3e shows a sectional view of the arrangement shown in FIGS. 3a to 3d.

FIG. 3f shows a detail of the sectional view shown in FIG. 3e.

FIG. 3g shows an isometric view of the four integrally formed clamping elements with base plate shown in FIGS. 3a to 3f.

FIG. 3h shows the arrangement shown in FIG. 3g in another isometric view.

FIG. 3i shows the arrangement shown in FIGS. 3g and 3h from above.

FIG. 3j shows the arrangement shown in FIGS. 3g to 3i from the front.

FIG. 3k shows the arrangement shown in FIGS. 3g to 3j from the side.

FIG. 4a shows a single preferred clamping element with holding area.

FIG. 4b shows a single preferred clamping element with a retaining area in the form of a protrusion.

FIG. 4c shows a single preferred clamping element with a holding area designed as an alternative protrusion.

FIG. 4d shows a side view of a single preferred clamping element in the form of a leaf spring element.

FIG. 4e shows a section of a preferred holding area with two angles in relation to the insertion direction of the battery in a side view.

FIG. 5a shows an isometric view of a preferred clamping element with a bulge running around two sides.

FIG. 5b shows a closed circumferential, preferred clamping element with a bulge from above.

FIG. 6a shows a section of a receiving space of a preferred hair cutting device or a preferred charger with two recesses in a sectional view.

FIG. 6b shows a sectional view of a receiving space of a preferred hair cutting device or a preferred charger with two clamping elements.

FIG. 6c shows the receiving space of a charger with plug-in connection shown in FIG. 6b.

FIG. 7a shows a preferred battery in an isometric sectional view.

FIG. 7b shows a section of a preferred battery with a recess.

FIG. 7c shows a section of a preferred battery with a circumferential groove.

FIG. 7d shows a section of a preferred battery with two clamping elements.

FIG. 7e shows a section of a preferred battery with a grip area.

### DESCRIPTION OF THE PREFERRED EMBODIMENTS

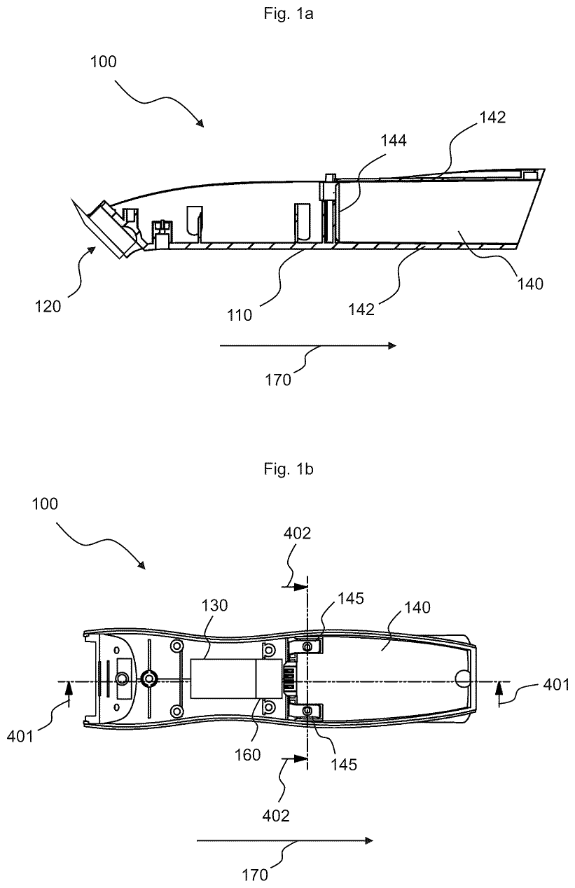

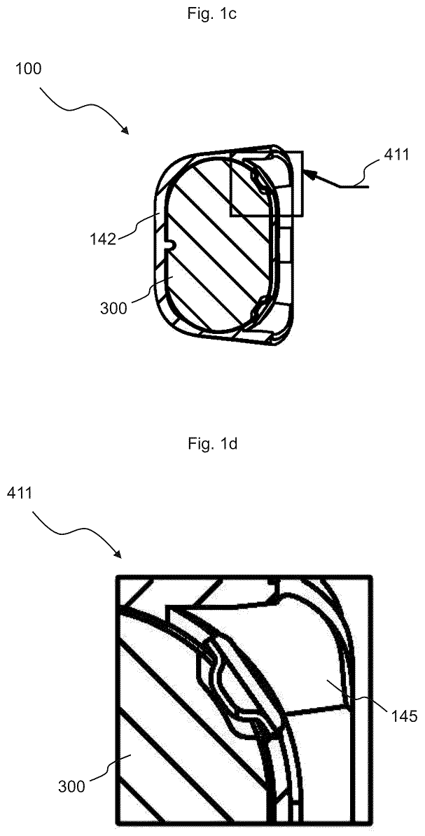

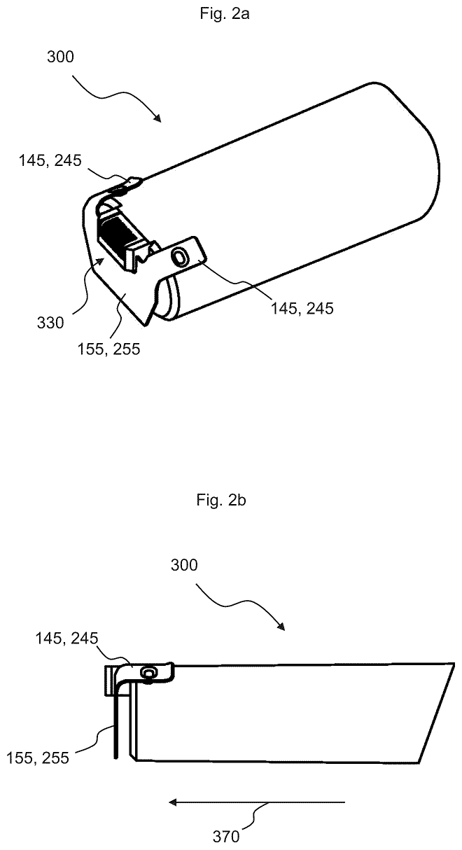

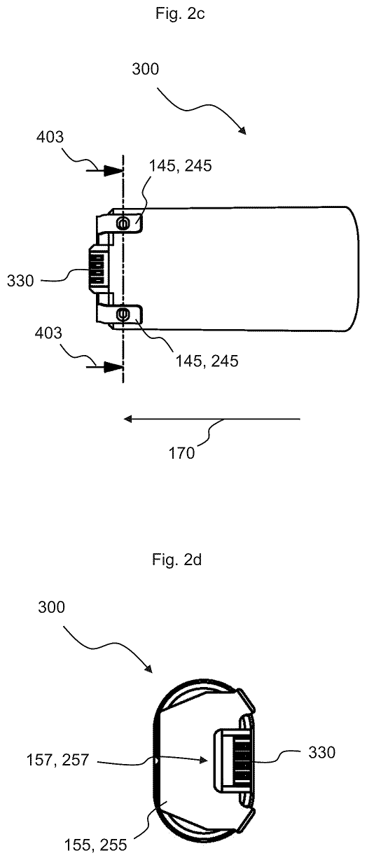

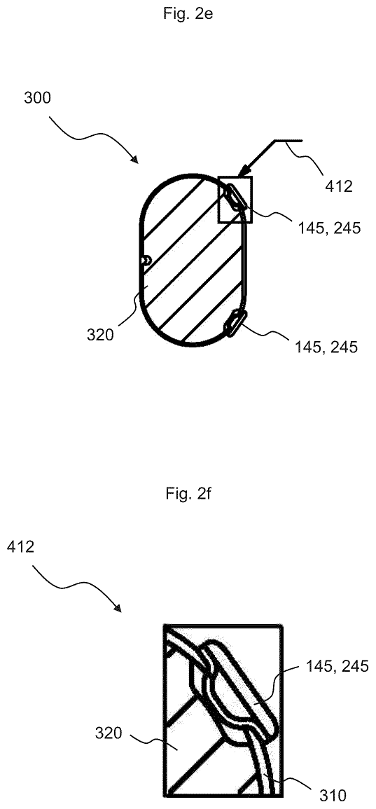

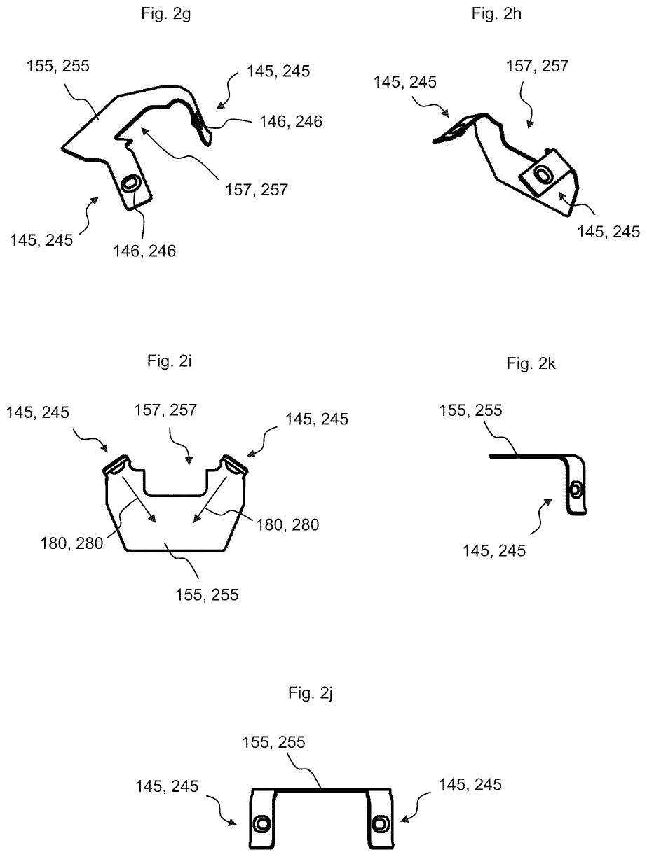

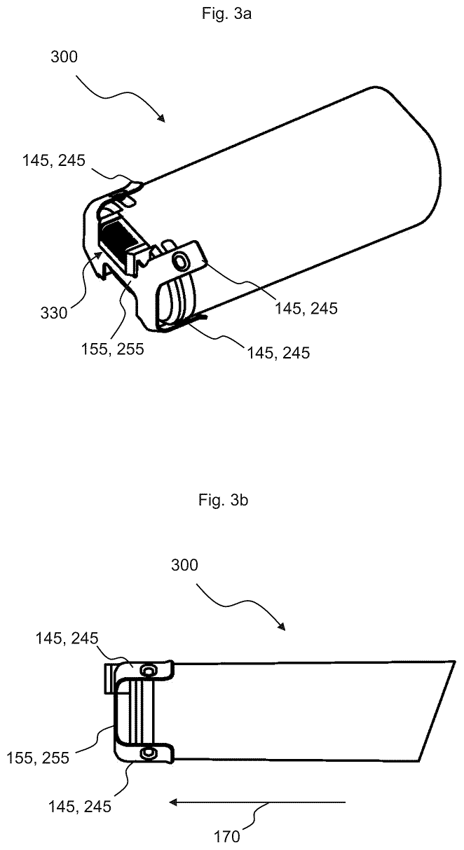

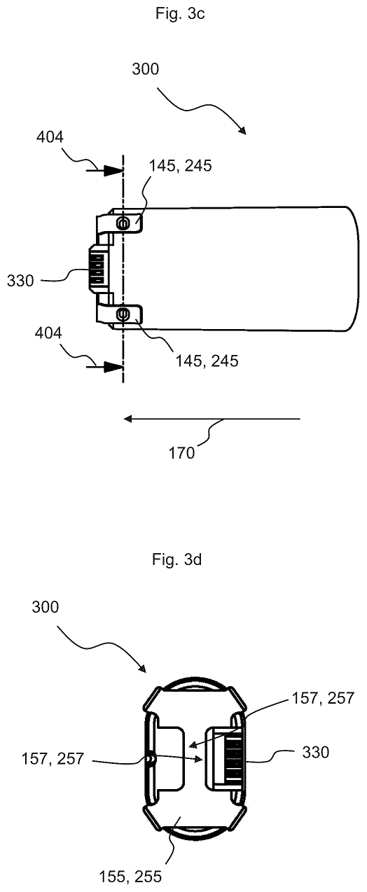

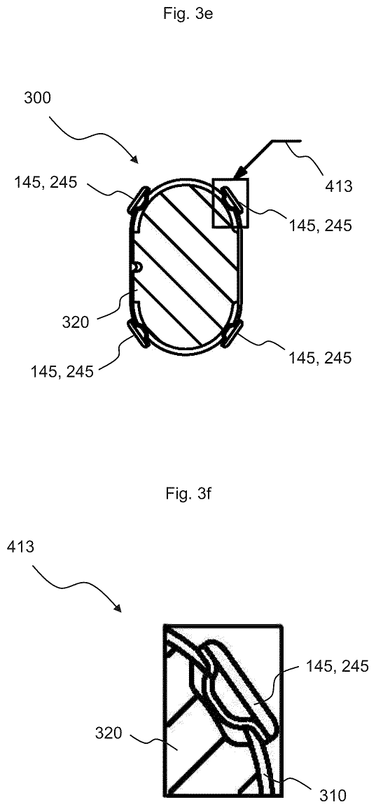

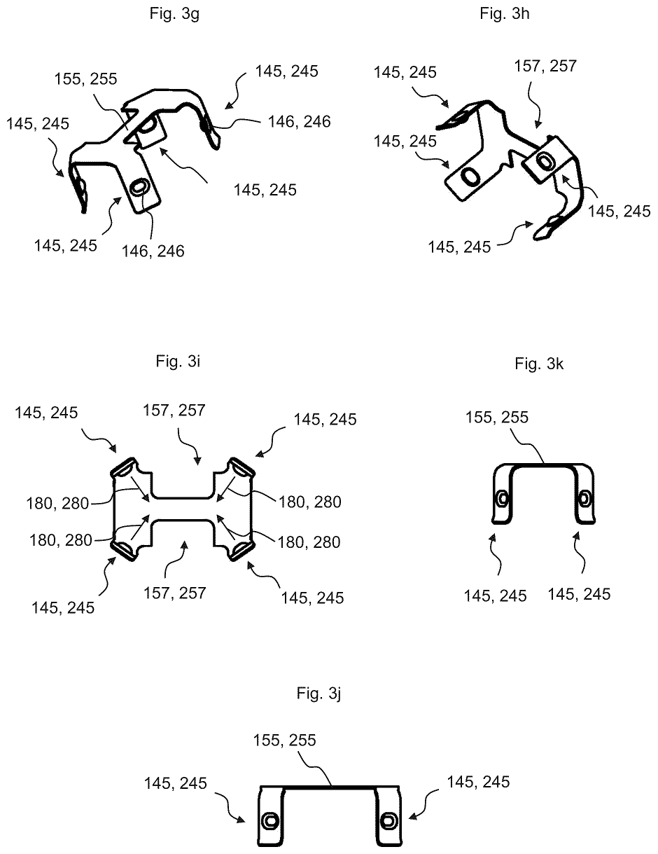

When the directional indications longitudinal direction 170, radial direction 180 and “circumferential” are used in the following, these refer to the longitudinal axis of the hair cutting device 100 or the receiving space 140. The longitudinal direction 170 is the direction along the longitudinal axis of the hair cutting device (in FIGS. 1a and 1b from left to right). This direction essentially corresponds to the main direction of the receiving space 140 or the insertion direction 370 of the battery 300 (for example in FIG. 2b from right to left), which thus points from the position of the clamping element 145 in the direction of the opening of the receiving space 140. The radial direction 180 is a direction perpendicular to the longitudinal direction 170, i.e. a direction that runs from the area of the wall 142 of the receiving space 140 to the center of the receiving space (see, for example, FIGS. 1a and 2i). If several clamping elements 145 are provided and distributed radially or circumferentially, each of the clamping elements 145 has its own radial direction 180 (see FIGS. 2i and 3i). All radial directions 180 point towards the center of the receiving space 140 or intersect there. A circumferential direction describes a direction around the longitudinal axis. This applies analogously to the receiving space 240 of a loading device 200.

FIG. 1a shows a preferred hair cutting device 100 in a side sectional view. On the left-hand side, the hair cutting device 100 has a blade assembly 120, which is arranged on a housing 110. Along the longitudinal direction 170, the hair cutting device 100 has a receiving space 140 on the right-hand side. A bottom 144 is arranged on its left side, which is positioned approximately centrally in relation to the hair cutting device 100. In FIG. 1a, the receiving chamber 140 also has two walls 142, one at the top and one at the bottom.

FIG. 1b shows a sectional view of the hair cutting device 100 shown in FIG. 1a. Section references 401, 402 are also shown. The section references 401 represent the sectional plane shown in FIG. 1a. The section references 402 represent the sectional plane shown in FIG. 1c. FIG. 1b also shows a motor 130 and a plug connection 160 arranged thereon. The motor 130 and the plug-in connection 160 are arranged on the left-hand side in the illustration. Furthermore, two clamping elements 145 are shown, which are arranged in the receiving space 140.

FIG. 1c shows a section through the receiving space 140 of the hair cutting device 100 shown in FIGS. 1a and 1b. The wall 142 completely encloses an battery 300. The battery 300 is thus located in the receiving space 140. A detail 411, which is shown enlarged in FIG. 1d, is shown in the top right of the illustration.

FIG. 1d shows the detail 411 of the section shown in FIG. 1c. A clamping element 145 is arranged at the outer edge of the hair cutting device 100 and touches the battery 300 or presses against it.

FIG. 2a shows a preferred battery 300 with two integrally formed clamping elements 145, 245 with base plate 155, 255 in the fixing position in an isometric view. Both clamping elements 145, 245 are in contact with the battery 300. A connection element 330 of the battery 300 is arranged between the clamping elements 145, 245. The clamping elements 145, 245 are integrally attached to the base plate 155, 255.

FIG. 2b shows a side view of the arrangement shown in FIG. 2a. There is a gap between the base plate 155, 255 and the battery. The clamping elements 145, 245 are arranged with the base plate 155, 255 along an insertion direction 370 of the battery 300 at the rear end.

FIG. 2c shows a top view of the arrangement shown in FIGS. 2a and 2b. Furthermore, two sectional references 403 are shown, which belong to the sectional plane shown in FIG. 2e.

FIG. 2d shows the arrangement shown in FIGS. 2a to 2c from below. The connecting element 330 is arranged in a recess 157, 257 of the base plate 155, 255. The recess 157, 257 surrounds the connecting element 330 on three sides.

FIG. 2e shows a sectional view of the arrangement shown in FIGS. 2a to 2d. The battery 300 has a battery component 320. The two clamping elements 145, 245 are connected to the battery 300. A detail 412, which is shown enlarged in FIG. 2f, is also shown in the top right of the illustration.

FIG. 2f shows the detail 412 of the sectional view shown in FIG. 2e. The battery component is surrounded on the outside by a casing 310. The illustrated clamping element 145, 245 protrudes into the outer contour of the casing 310.

FIG. 2g shows an isometric view of the two integrally formed clamping elements 145, 245 with base plate 155, 255 shown in FIGS. 2a to 2f. Both clamping elements 145, 245 each have a retaining area 146, 246. The recess 157, 257 is arranged between the clamping elements 145, 245.

FIG. 2h shows the arrangement shown in FIG. 2g in another isometric view.

FIG. 2i shows the arrangement shown in FIGS. 2g and 2h from above. Both clamping elements 145, 245 each have a radial direction 180, 280, which run towards each other. Both clamping elements 145, 245 are aligned with each other in such a way that their radial directions 180, 280 both point downwards in the illustration of FIG. 2i.

FIG. 2j shows the arrangement shown in FIGS. 2g to 2i from the front. Both clamping elements 145, 245 point essentially vertically away from the base plate 155, 255. This is also evident from FIG. 2k, which shows the arrangement shown in FIGS. 2g to 2j from the side.

FIG. 3a shows a preferred battery 300 with four integrally molded clamping elements 145, 245 with base plate 155, 255 in the fixing position in an isometric view. All four clamping elements 145, 245 touch the battery 300, whereby only three clamping elements 145, 245 are visible in the illustration of FIG. 3a. A connection element 330 of the battery 300 is arranged between the upper clamping elements 145, 245 in the illustration. The clamping elements 145, 245 are attached in one piece to the base plate 155, 255.

FIG. 3b shows a side view of the arrangement shown in FIG. 3a. There is a gap between the base plate 155, 255 and the battery. The clamping elements 145, 245 are arranged with the base plate 155, 255 along an insertion direction 370 of the battery 300 at the rear end.

FIG. 3c shows a top view of the arrangement shown in FIGS. 3a and 3b. Furthermore, two sectional references 404 are shown, which belong to the sectional plane shown in FIG. 3e.

FIG. 3d shows the arrangement shown in FIGS. 3a to 3c from below. The connecting element 330 is arranged in a recess 157, 257 of the base plate 155, 255 arranged on the right in the representation of FIG. 3d. A second recess 157, 257 is arranged on the left-hand side as shown in FIG. 3d. This left-hand recess 157, 257 is identical to the right-hand recess 157, 257. In this way, it is basically possible to use the battery 300 both in the right-hand direction and in the left-hand direction, so that the connection element 330 is either on the right or on the left. The right-hand recess 157, 257 encloses the connection element 330 on three sides.

FIG. 3e shows a sectional view of the arrangement shown in FIGS. 3a to 3d. The battery 300 has a battery component 320. The four terminal elements 145, 245 are connected to the battery 300. A detail 413, which is shown enlarged in FIG. 3f, is also shown in the top right of the illustration.

FIG. 3f shows detail 413 of the sectional view shown in FIG. 3e. The description of detail 412 applies analogously to detail 413.

FIG. 3g shows an isometric view of the four integrally molded clamping elements 145, 245 with base plate 155, 255 shown in FIGS. 3a to 3f. All four clamping elements 145, 245 each have a retaining area 146, 246. One of the recesses 157, 257 is arranged between each two clamping elements 145, 245.

FIG. 3h shows the arrangement shown in FIG. 3g in another isometric view.

FIG. 3i shows the arrangement shown in FIGS. 3g and 3h from above. All four clamping elements 145, 245 each have a radial direction 180, 280, which run towards each other. Both of the upper clamping elements 145, 245 in the representation of FIG. 3i are aligned with one another in such a way that their radial directions 180, 280 both point downwards in the representation of FIG. 3i. Similarly, both lower clamping elements 145, 245 in the representation of FIG. 3i are aligned with each other in such a way that their radial directions 180, 280 both point upwards in the representation of FIG. 3i.

FIG. 3j shows the arrangement shown in FIGS. 3g to 3i from the front. Of the four clamping elements 145, 245, only the two front ones are visible. Both clamping elements 145, 245 visible in the illustration of FIG. 3j point essentially vertically away from the base plate 155, 255. This can also be seen in FIG. 3k, which shows the arrangement shown in FIGS. 3g to 3j from the side.

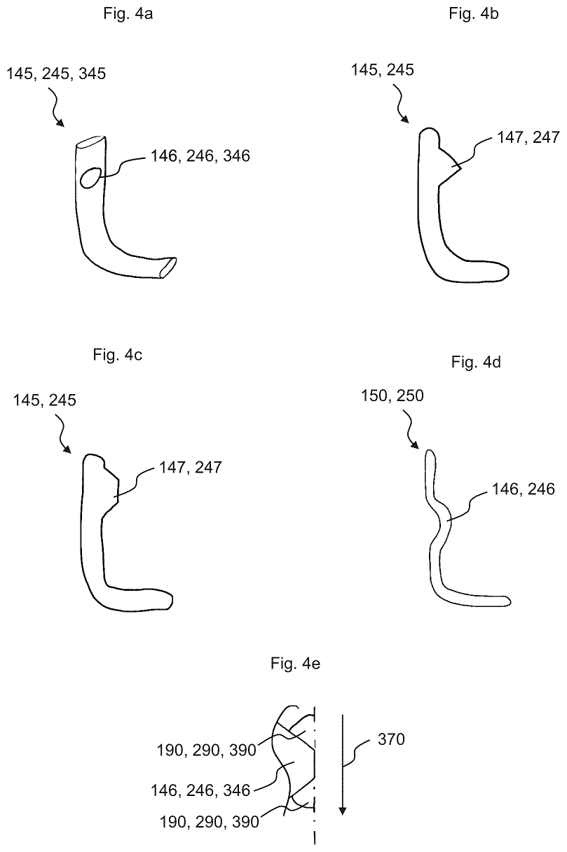

FIG. 4a shows a single preferred clamping element 145, 245, 345 with holding area 146, 246, 346.

FIG. 4b shows a single preferred clamping element 145, 245 with a retaining area formed as a projection 147, 247. The projection 147, 247 is tapered.

FIG. 4c shows a single preferred clamping element 145, 245 with a retaining area formed as an alternative projection 147, 247. Here, unlike in FIG. 4b, the projection 147, 247 is designed with a flat surface.

FIG. 4d shows a side view of a single preferred clamping element in the form of a leaf spring element 150, 250. The retaining area 146, 246 of the leaf spring element 150, 250 is designed as a tapered or bulging area without the diameter of the leaf spring element 150, 250 being locally increased. In contrast to the clamping elements 145, 245 shown in FIGS. 4b and 4c, material can be saved with the design of the clamping element as leaf spring element 150, 250 shown in FIG. 4d.

FIG. 4e shows a section of a preferred holding area 146, 246, 346 with two angles 190, 290, 390 in relation to the insertion direction 370 of the battery 300 in a side view. As shown, the angles 190, 290, 390 result from the insertion direction 370 and a side surface of the holding area 146, 246, 346 that is inclined with respect to this insertion direction 370. In each case, the smallest angle between the side surfaces and the insertion direction 370 is used. In the illustration in FIG. 4e, both angles 190, 290, 390 are approximately 45°.

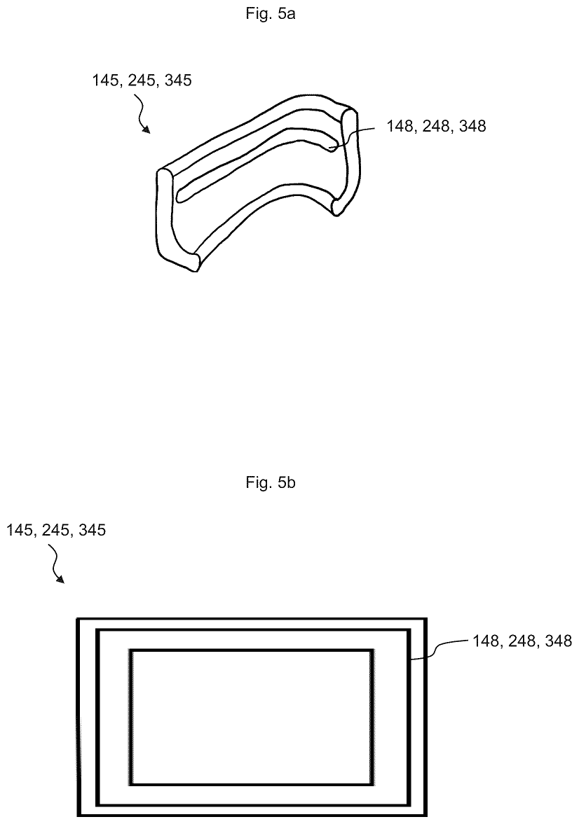

FIG. 5a shows an isometric view of a preferred clamping element 145, 245, 345 with a bead 148, 248, 348 extending around two sides.

FIG. 5b shows a preferred clamping element 145, 245, 345 with a bead 148, 248, 348 from above.

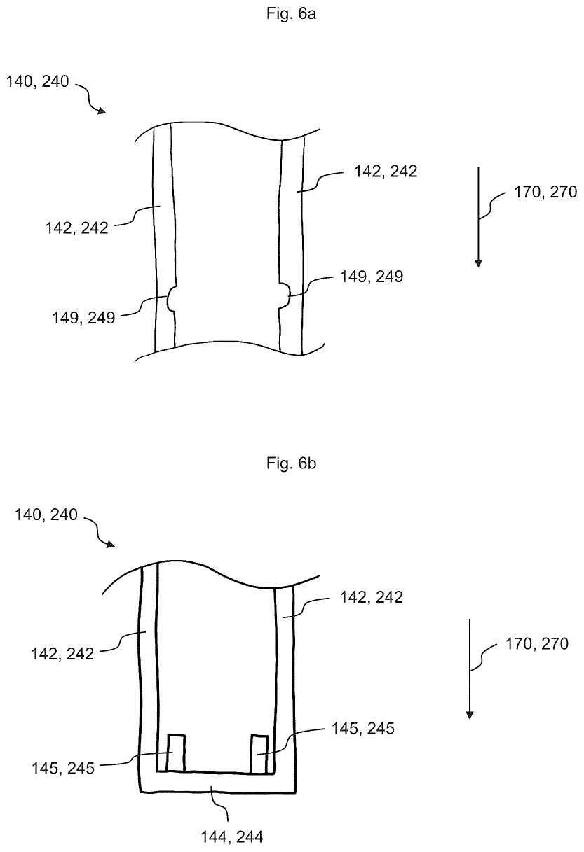

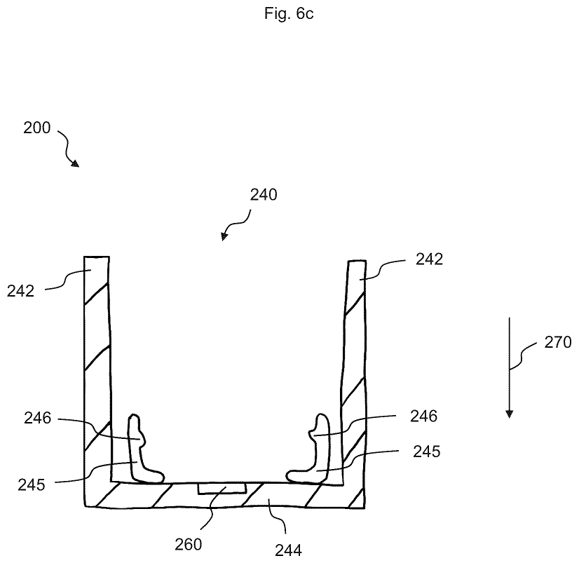

FIG. 6a shows a section of a receiving space 140, 240 of a preferred hair cutting device 100 or a preferred charger 200 with two recesses 149, 249 in a sectional view. Both recesses are each located in a wall 142, 242. Both walls 142, 242 run parallel to a longitudinal direction 170, 270.

FIG. 6b shows a sectional view of a receiving space 140, 240 of a preferred hair cutting device 100 or a preferred charger 200 with two clamping elements 145, 245. Both clamping elements 145, 245 are arranged on a bottom 144, 244, which is arranged along a longitudinal direction 170, 270 at the lower end of the receiving space 140, 240.

FIG. 6c shows the receiving space 240 of a charger 200 with plug-in connection 260 shown in FIG. 6b. The plug-in connection 260 is embedded in the bottom 244. The two clamping elements 245 are arranged on the bottom 244, the holding areas 246 of which are directed towards each other. The receiving space 240 is open at the top in the illustration of FIGS. 6c.

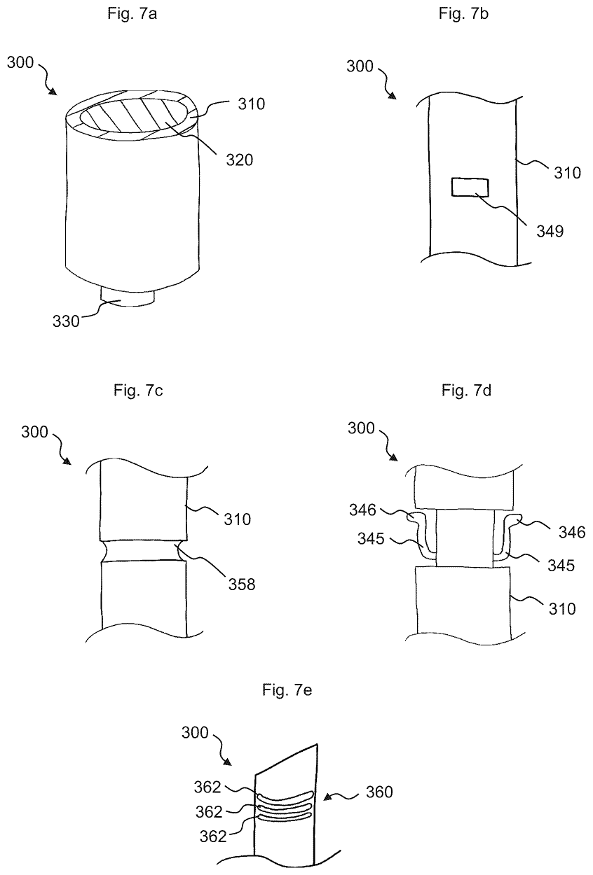

FIG. 7a shows a preferred battery 300 in an isometric sectional view. The battery has a casing 310. The casing 310 completely surrounds a battery component 320. A connection element 330 is arranged at the lower end of the battery as shown in FIG. 7a.

FIG. 7b shows a section of a preferred rechargeable battery 300 with recess 349. The recess 349 is arranged on a casing 310 of the rechargeable battery 300 or is recessed into the casing 310.

FIG. 7c shows a section of a preferred battery 300 with a circumferential groove 358. The groove is arranged on a casing 310 of the battery 300 or is recessed into the casing 310.

FIG. 7d shows a section of a preferred battery 300 with two clamping elements 345. The two clamping elements 345 are arranged on opposite sides and each have a retaining area 346. At the positions of the clamping elements 345, the battery 300 is recessed in order to provide space for the positioning of the clamping elements 345.

FIG. 7e shows a section of a preferred battery 300 with a grip area 360. The grip area 360 is formed here from three superimposed grooves 362.

### LIST OF REFERENCE NUMBERS

100 Hair-cutting device
110 Housing
120 Blade assembly
130 Motor
140 Receiving space
142 Wall
144 Bottom
145 Clamping element
146 Holding area
147 Protrusion
148 Bulge
149 Recess
150 Leaf spring element
155 Base plate
157 Recess
160 Plug connection
170 Longitudinal direction
180 Radial direction
190 Angle
200 Charger
240 Receiving space
242 Wall
244 Bottom
245 Clamping element
246 Holding area
247 Protrusion
248 Bulge
249 Recess
250 Leaf spring element
255 Base plate
257 Recess
260 Plug connection
270 Longitudinal direction
280 Radial direction
290 Angle
300 Battery
310 Sleeve
320 Battery component
330 Connecting element
345 Clamping element
346 Holding area
348 Bulge
349 Recess
358 Groove
360 Grip area
362 Groove
370 Insertion direction
390 Angle
401 Section reference
402 Section reference
403 Section reference
404 Section reference
411 Detail
412 Detail
413 Detail

1.-17. (canceled)

18. A hair cutting device (100) comprising
a housing (110);
a blade assembly (120) for cutting hair;
a motor (130) for driving the blade assembly (120), which is arranged in the housing (110);
a receiving space (140) for at least partially receiving a battery (300), the receiving space (140) being arranged in the housing (110) and having, in the longitudinal direction (170), at least one bottom (144) and circumferentially one wall (142) or a plurality of walls (142) which delimit the receiving space (140); and
a plug-in connection (160) for plugging in the battery (300), the plug-in connection (160) being electrically connected to the motor (130),
wherein
the receiving space (140) has circumferentially at least one elastic or elastically mounted clamping element (145), with which a radially inwardly directed pressure can be exerted via a holding area (146) on the battery (300) received in the receiving space (140),
or
the receiving space (140) has circumferentially at least one recess (149) for receiving an elastic or elastically mounted clamping element (345) arranged on the battery (300) received in the receiving space (140).

19. Charger (200) for a battery (300), comprising
a connection which can be connected to a power supply;
a converter which converts the current and the voltage from the mains supply into a current and voltage appropriate for a battery (300);
a plug connection (260) for plugging in the battery (300), so that the battery (300) can be supplied with the converted current and voltage; and
a receiving space (240) for at least partially receiving a battery (300), the receiving space (240) being arranged in the housing (110) and having, in the longitudinal direction (270), at least one bottom (244) and circumferentially one wall (242) or a plurality of walls (242) which delimit the receiving space (240);
wherein
the receiving space (240) has circumferentially at least one elastic or elastically mounted clamping element (245), with which a radially inwardly directed pressure can be exerted via a holding area (246) on the battery (300) received in the receiving space (240),
or
the receiving space (240) has circumferentially at least one recess (249) for receiving an elastic or elastically mounted clamping element (345) arranged on the battery (300) received in the receiving space (240).

20. Hair cutting device (100) or charger (200) according to claim 18, wherein the clamping element (145, 245) is designed as a circumferential bulge (148, 248) or the hair cutting device (100) or the charger (200) has a plurality of circumferentially arranged clamping elements (145, 245).

21. Hair cutting device (100) or charger (200) according to claim 18, wherein an angle (190, 290) between the outer surface of the holding area (146, 246) and an insertion direction (370) of the battery (300) is less than 75° and greater than 10°.

22. Hair cutting device (100) or charger (200) according to claim 18, wherein the clamping element (145, 245) is formed from an elastically deformable plastic.

23. Hair cutting device (100) or charger (200) according to claim 18, wherein the at least one clamping element (145, 245) is formed as a flat leaf spring element (150, 250) which protrudes in the longitudinal direction (170, 270) into the receiving space (140, 240) and is biased in the radial direction (180, 280).

24. Hair cutting device (100) or charger (200) according to claim 23, in which the clamping element (145, 245) is arranged to a base plate (155, 255) which is arranged at the bottom (144, 244) of the receiving space (140, 240).

25. Hair cutting device (100) or charger (200) according to claim 23, comprising at least two clamping elements (145, 245), of which at least two are at least partially directed towards each other.

26. Hair cutting device (100) or charger (200) according to claim 24, wherein the base plate (155, 255) has a recess (157, 257) through which the battery (300) can be connected to the plug-in connection (260).

27. Hair cutting device (100) or charger (200) according to claim 18, wherein the clamping element (145, 245) is formed from a metal or plastic.

28. Hair cutting device (100) or charger (200) according to claim 18, wherein the holding area (146, 246) is formed without edges.

29. Battery (300) for a hair cutting device (100) according to claim 18, comprising
at least one battery component (320)
a housing (310) in which the at least one battery component (320) is housed, and
a connection element (330) which can be connected to the plug-in connection (260) of the hair cutting device (100),
wherein
at least one elastic or elastically mounted clamping element (345) is arranged circumferentially on the outside of the sleeve (310), which exerts a radially outwardly directed pressure on the receiving space (140) via a retaining area (346),
or
at least one recess (349) for receiving an elastic or elastically mounted clamping element (145) arranged in the receiving space (140) of the hair cutting device (100) is arranged circumferentially on the outside of the sleeve (310).

30. Battery (300) according to claim 29, wherein at least one elastic or elastically mounted clamping element (345) is arranged circumferentially on the outside of the sleeve (310), exerting a radially outwardly directed pressure on the receiving space (140) via a retaining area (346),
wherein the clamping element (345) is designed as a circumferential bulge (348) or the battery (300) has a plurality of circumferentially arranged clamping elements (345).

31. Battery (300) according to claim 29, wherein an angle (390) between the outer surface of the holding area (346) and an insertion direction (370) of the battery (300) is less than 75° and greater than 10°.

32. Battery (300) according to claim 29, wherein at least one elastic or elastically mounted clamping element (345) is arranged circumferentially on the outside of the sleeve (310), exerting a radially outwardly directed pressure on the receiving space (140) via a retaining area (346),
wherein the clamping element (345) is formed from an elastically deformable plastic.

33. Battery (300) according to claim 29, wherein at least one recess (349) for receiving an elastic or elastically mounted clamping element (145) arranged in the receiving space (140) of the hair cutting device (100) is arranged circumferentially on the outside of the sleeve (310),
wherein the recess (349) is formed as an at least substantially circumferential groove (358).

34. Battery (300) according to claim 29. further comprising a grip area (360).
